(19) United States
(12) Patent Application Publication
(10) Pub. No.: US 2020/0068461 A1
(43) Pub. Date: Feb. 27, 2020

(54) Method of Sending Cell Measurement Configuration Information and Device Thereof, Method of Receiving Cell Measurement Configuration Information and Device Thereof

(71) Applicants: CHINA MOBILE COMMUNICATION LTD, RESEARCH INSTITUTE, Beijing (CN); CHINA MOBILE COMMUNICATIONS CORPORATION, Beijing (CN)

(72) Inventors: Nan Hu, Beijing (CN); Na Ll, Beijing (CN); Ningyu Chen, Beijing (CN); Xiaoran Zhang, Beijing (CN)

(21) Appl. No.: 16/346,410

(22) PCT Filed: Nov. 2, 2017
(86) PCT No.: PCT/CN2017/109020

§ 371 Date: Apr. 30, 2019

(30) Foreign Application Priority Data
Nov. 4, 2016 (CN) 201610974651.X

(51) Int. Cl. H04W 36/00; H04W 36/08; H04W 36/16

(52) U.S. Cl. CPC H04W 36/0085; H04W 36/0072; H04W 36/165; H04W 36/0061; H04W 36/08; H04W 36/0077

(57) ABSTRACT

A method of sending cell measurement configuration information and a device thereof, and a method of receiving cell measurement configuration information and a device thereof are provided. The method of sending cell measurement configuration information includes: sending, by a network device through a dedicated signaling, to a terminal first measurement configuration information used by the terminal, where the first measurement configuration information includes cell change configuration information and indication information configured to identify the cell change configuration information; sending, by the network device, second measurement configuration information through a system broadcast message, where the second measurement configuration information includes cell change configuration indication information.

### CROSS REFERENCE OF RELATED APPLICATION

The present application claims a priority of Chinese patent application No. 201610974651.X filed on Nov. 4, 2016, which is incorporated herein by reference in its entirety.

### TECHNICAL FIELD

The present disclosure relates to the field of communications, and in particular, to a method of sending cell measurement configuration information and a device thereof, and a method of receiving cell measurement configuration information and a device thereof.

### BACKGROUND

Long Term Evolution (LTE) is a long-term evolution of the Universal Mobile Telecommunications System (UMTS) technology standard developed by the 3rd Generation Partnership Project (3GPP).

When the terminal needs to perform the serving cell change, the terminal receives the configuration information of the neighboring cell sent by the network side, so as to implement a measurement on the neighboring cell, and then perform the cell change. If the terminal is in the radio resource control (RRC) connection state, the cell handover is performed. If the terminal is in the RRC idle state, the cell reselection is performed. The terminal performs the measurement on the neighbor cell broadcast according to the system broadcast message sent by the network side.

However, through the neighbor cell configuration information sent by the network side in the related art, the frequency point that the terminal cannot measure may be sent to the terminal.

### SUMMARY

The embodiments of the present disclosure provides a method of sending cell measurement configuration information and a device thereof, and a device of receiving cell measurement configuration information and a device thereof, so as to implement the cell change more flexibly.

A method of sending cell measurement configuration information is provided in the present disclosure, including:

sending, by a network device through a dedicated signaling, to a terminal first measurement configuration information used by the terminal, where the first measurement configuration information includes cell change configuration information and indication information configured to identify the cell change configuration information;

sending, by the network device, second measurement configuration information through a system broadcast message, where the second measurement configuration information includes cell change configuration indication information.

Optionally, the cell change configuration information used by the terminal is determined according to a capability of the terminal.

Optionally, the method further includes:

receiving, by the network device, an acquisition request of the first measurement configuration information sent by the terminal, where the acquisition request is sent by a terminal from a first region after the terminal from the first region accessing a second region where the network device is located;

sending, by the network device through the dedicated signaling, the first measurement configuration information to the terminal that sends the acquisition request.

Optionally, the first region is corresponding to a first MME, the second region is corresponding to a second MME, or

the first region is corresponding to a first cell group, the second region is corresponding to a second cell group, the first cell group includes N cells, N is an integer greater than or equal to 1, the second cell group includes M cells, M is an integer greater than or equal to 1.

Optionally, the cell change configuration information and the indication information configured to identify the cell change configuration information include: a correspondence between the cell change configuration information and cell change configuration index numbers;

the different cell change configuration index numbers used by the terminal correspond to different cell change configuration information;

the cell change configuration information corresponding to a same cell change configuration index number used by different terminals is the same or different.

Optionally, the cell change configuration information includes one or more of: a frequency point and a bandwidth allowable to be measured; and a serving cell identity.

A method of receiving cell measurement configuration information is further provided in the present disclosure, including:

receiving, by a terminal through a dedicated signaling, first measurement configuration information used by the terminal which is sent by a network device, where the first measurement configuration information includes cell change configuration information and indication information configured to identify the cell change configuration information;

receiving, by the terminal through a system broadcast message, second measurement configuration information sent by the network device, where the second measurement configuration information includes cell change configuration indication information; and

performing, by the terminal, a cell measurement based on the cell change configuration information corresponding to the cell change configuration indication information.

Optionally, the cell change configuration information used by the terminal is determined according to a capability of the terminal.

Optionally, the method further includes:

sending, by the terminal, an acquisition request of the first measurement configuration information to the network device, after the terminal enters from a first region to a second region where the network device is located;

receiving, by the terminal, the first measurement configuration information sent by the network device through the dedicated signaling.

Optionally, the first region is corresponding to a first MME, the second region is corresponding to a second MME, or

the first region is corresponding to a first cell group, the second region is corresponding to a second cell group, the first cell group includes N cells, N is an integer greater than or equal to 1, the second cell group includes M cells, M is an integer greater than or equal to 1.

Optionally, the cell change configuration information and the indication information configured to identify the cell change configuration information include: a correspondence between the cell change configuration information and cell change configuration index numbers;

the different cell change configuration index numbers used by the terminal correspond to different cell change configuration information;

the cell change configuration information corresponding to a same cell change configuration index number used by different terminals is the same or different.

Optionally, the cell change configuration information includes one or more of: a frequency point and a bandwidth allowable to be measured; and a serving cell identity.

A network device is further provided in the present disclosure, including:

a first sending module, configured to send, through a dedicated signaling, to a terminal first measurement configuration information used by the terminal, where the first measurement configuration information includes cell change configuration information and indication information configured to identify the cell change configuration information;

a second sending module, configured to send, second measurement configuration information through a system broadcast message, where the second measurement configuration information includes cell change configuration indication information.

Optionally, the cell change configuration information used by the terminal is determined according to a capability of the terminal.

Optionally, the network device further includes:

a receiving module, configured to receive an acquisition request of the first measurement configuration information sent by the terminal, where the acquisition request is sent by a terminal from a first region after the terminal from the first region accessing a second region where the network device is located;

where the first sending module is further configured to send, through the dedicated signaling, the first measurement configuration information to the terminal that sends the acquisition request.

Optionally, the first region is corresponding to a first MME, the second region is corresponding to a second MME, or

the first region is corresponding to a first cell group, the second region is corresponding to a second cell group, the first cell group includes N cells, N is an integer greater than or equal to 1, the second cell group includes M cells, M is an integer greater than or equal to 1.

Optionally, the cell change configuration information and the indication information configured to identify the cell change configuration information include: a correspondence between the cell change configuration information and cell change configuration index numbers;

the different cell change configuration index numbers used by the terminal correspond to different cell change configuration information;

the cell change configuration information corresponding to a same cell change configuration index number used by different terminals is the same or different.

Optionally, the cell change configuration information includes one or more of: a frequency point and a bandwidth allowable to be measured; and a serving cell identity.

A terminal is further provided in the present disclosure, including:

a first receiving module, configured to receive, through a dedicated signaling, first measurement configuration information used by the terminal which is sent by a network device, where the first measurement configuration information includes cell change configuration information and indication information configured to identify the cell change configuration information;

a second receiving module, configured to receive, through a system broadcast message, second measurement configuration information sent by the network device, where the second measurement configuration information includes cell change configuration indication information; and

a measurement module, configured to perform a cell measurement based on the cell change configuration information corresponding to the cell change configuration indication information.

Optionally, the cell change configuration information used by the terminal is determined according to a capability of the terminal.

Optionally, the terminal further includes:

a sending module, configured to send an acquisition request of the first measurement configuration information to the network device, after the terminal enters from a first region to a second region where the network device is located;

where the first receiving module is further configured to receive the first measurement configuration information sent by the network device through the dedicated signaling, in the case that the sending module sends the acquisition request of the first measurement configuration information.

Optionally, the first region is corresponding to a first MME, the second region is corresponding to a second MME, or

the first region is corresponding to a first cell group, the second region is corresponding to a second cell group, the first cell group includes N cells, N is an integer greater than or equal to 1, the second cell group includes M cells, M is an integer greater than or equal to 1.

Optionally, the cell change configuration information and the indication information configured to identify the cell change configuration information include: a correspondence between the cell change configuration information and cell change configuration index numbers;

the different cell change configuration index numbers used by the terminal correspond to different cell change configuration information;

the cell change configuration information corresponding to a same cell change configuration index number used by different terminals is the same or different.

Optionally, the cell change configuration information includes one or more of: a frequency point and a bandwidth allowable to be measured; and a serving cell identity.

A network device is further provided in the present disclosure, including a transceiver, a processor and a memory configured to store a program or data used by the processor when performing an operation, where

the processor is configured to generate first measurement configuration information used by a terminal;

the transceiver is configured to send the first measurement configuration information to the terminal through a dedicated signaling, where the first measurement configuration information includes cell change configuration information and indication information configured to identify the cell change configuration information;

the processor is further configured to generate second measurement configuration information; and

the transceiver is further configured to send second measurement configuration information through a system broadcast message, where the second measurement configuration information includes cell change configuration indication information.

A terminal is further provided in the present disclosure, including a transceiver, a processor and a memory configured to store a program or data used by the processor when performing an operation, where

the transceiver is configured to receive, through a dedicated signaling, first measurement configuration information used by the terminal which is sent by a network device, where the first measurement configuration information includes cell change configuration information and indication information configured to identify the cell change configuration information, and configured to receive, through a system broadcast message, second measurement configuration information sent by the network device, where the second measurement configuration information includes cell change configuration indication information; and

the processor is configured to perform a cell measurement based on the cell change configuration information corresponding to the cell change configuration indication information.

A computer readable storage medium is further provided in the present disclosure, where the computer readable storage medium stores instructions to:

send, through a dedicated signaling, to a terminal first measurement configuration information used by the terminal, where the first measurement configuration information includes cell change configuration information and indication information configured to identify the cell change configuration information;

send second measurement configuration information through a system broadcast message, where the second measurement configuration information includes cell change configuration indication information.

A computer readable storage medium is further provided in the present disclosure, where the computer readable storage medium stores instructions to:

receive, through a dedicated signaling, first measurement configuration information used by the terminal which is sent by a network device, where the first measurement configuration information includes cell change configuration information and indication information configured to identify the cell change configuration information;

receive, through a system broadcast message, second measurement configuration information sent by the network device, where the second measurement configuration information includes cell change configuration indication information; and

perform a cell measurement based on the cell change configuration information corresponding to the cell change configuration indication information.

According to the embodiments of the present disclosure, a network device sends, through a dedicated signaling, to a terminal first measurement configuration information used by the terminal, where the first measurement configuration information includes cell change configuration information and indication information configured to identify the cell change configuration information, and sends second measurement configuration information through a system broadcast message, where the second measurement configuration information includes cell change configuration indication information, so as to enable the terminal that receives the second measurement configuration information to perform the cell measurement based on the cell change configuration information corresponding to the cell change configuration indication information in the second measurement configuration information. Since the network device sends the measurement configuration information indication information, the signaling overhead of the system broadcast message may be saved.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a flowchart of a method for sending cell measurement configuration information in some embodiments of the present disclosure;

FIG. 2 is a flowchart of a method for receiving cell measurement configuration information in some embodiments of the present disclosure;

FIG. 3 is a schematic view of a network device in some embodiments of the present disclosure; and

FIG. 4 is a schematic view of a terminal in some embodiments of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

The network device in the embodiment of the present disclosure may be an evolved base station, a macro base station, a micro base station (also referred to as a “small base station”), a pico base station, and the like in the LTE system, and the disclosure is not limited thereto.

The terminal in the embodiment of the present disclosure includes various types of user equipment, mobile station (MS), terminal, terminal equipment, and the like.

At present, the cell change configuration information sent by the network device to the terminal does not consider the measurement capability of the terminal, and the frequency point information that the terminal does not support the measurement may be sent to the terminal. In order to solve the above technical issues, an embodiment of the present disclosure provides a method for transmitting and receiving cell measurement configuration information.

Referring to FIG. 1, a method of sending cell measurement configuration information and a method of receiving cell measurement configuration information are provided. As shown in the drawings, the method includes the following steps:

Step 101: sending, by a network device through a dedicated signaling, to a terminal first measurement configuration information used by the terminal, where the first measurement configuration information includes cell change configuration information and indication information configured to identify the cell change configuration information.

Step 102: sending, by the network device, second measurement configuration information through a system broadcast message, where the second measurement configuration information includes cell change configuration indication information.

In the foregoing Step 102, the network device sends the second measurement configuration information through the system broadcast message, so that after receiving the second measurement configuration information, the terminal may perform the cell measurement based on the cell change configuration information corresponding to the cell change configuration indication information in the second measurement configuration information.

Optionally, the first measurement configuration information further includes a preset threshold for triggering cell change, that is, when the terminal detects that the signal quality of the serving cell of the terminal is lower than the preset threshold, the terminal is triggered to perform the cell change.

Optionally, the terminal reports a measurement capability of the terminal to the network device when performing a network attachment, and then the network device may report the measurement capability of the terminal to the upper-level network node for the network device. The upper-level network node may be a Mobility Management Entity (MME); or the upper-level network node may be a group leader of a cell group in which the network device is located, and the cell group is composed of several cells, and the group leader of the cell group may be one of the plurality of cells pre-agreed. After receiving the measurement capability of the terminal, the upper-level network node for the network device may generate, according to the measurement capability of the terminal, cell change configuration information for the terminal and indication information for indicating the cell change configuration information. When the upper-level network node is the MME, the network node may send the generated cell change configuration information and the indication information for indicating the cell change configuration information to the network device through the S1-MME interface. When the upper-level network node is the group leader of the cell group, the network node may send the generated cell change configuration information and the indication information for indicating the cell change configuration information to the network device through an interface between the cells.

The cell change configuration information and the indication information configured to identify the cell change configuration information are generated by the upper-level network node for the network device, so within the region corresponding to the network node, the correspondence between the cell change configuration information and the indication information for identifying the cell change configuration information is valid. After the terminal leaves the region corresponding to the upper-level network node for the network device, the cell change configuration information and the indication information configured to identify the cell change configuration information may be invalid, and the terminal may send an acquisition request of the first measurement configuration information to the network device in a new region, so as to obtain the cell change configuration information and the indication information configured to identify cell change configuration information in the new region. Correspondingly, after the network device in the new region receives the acquisition request of the first measurement configuration information sent by the terminal, the first measurement configuration information may be sent to the terminal through the dedicated signaling, where the first measurement configuration information includes the cell change configuration information and the indication information configured to identify cell change configuration information in the new region.

Optionally, the above cell change configuration indication information may be a cell change configuration index number, and the cell change configuration information and indication information configured to identify the cell change configuration information may include a correspondence between the cell change configuration information and cell change configuration index numbers. In the correspondence between the cell change configuration information and the cell change configuration index numbers of the same terminal, different cell change configuration index numbers correspond to different cell change configuration information. The network device sends the index numbers of the cell change configuration information to the terminal, and the terminal determines the cell change configuration information according to the index numbers of the received cell change configuration information and the correspondence between the cell change configuration information and the index number received in the attaching process.

The correspondence between the cell change configuration information and the index number is generated by the upper-level network node of the network device according to the measurement capability of the terminal, and therefore, for different terminals, the cell change configuration information corresponding to the same cell change configuration index number may be the same or different.

Optionally, the cell change configuration information includes one or more of:

a frequency point and a bandwidth allowable to be measured; and

a serving cell identity.

For example, the cell configuration information corresponding to index number 1 is: frequency point E and frequency point F, the bandwidth is 200M, and the cell identifier is xxxx; the cell configuration information corresponding to index number 2 is: frequency point G, bandwidth 200M, cell identifier yyyy.

Optionally, the cell change configuration indication information may be indication information for instructing the terminal to acquire the cell change configuration information through the system broadcast message. In some embodiments, an index number may be reserved from the index numbers, where the reserved index number does not correspond to specific cell change configuration information, and when the network device sends the reserved index number to the terminal, it means that the network device will send the cell change configuration information through the system broadcast message.

In some embodiments of the present disclosure, after the terminal receives the second measurement configuration information that is sent by the network device and includes the cell change configuration indication information but does not find the cell change configuration information corresponding to the cell change configuration indication information in the correspondence between the cell change configuration information and the indication information configured to identify the cell change configuration information, the terminal may send to the network device an acquisition request of the cell change configuration information. After receiving the acquisition request of the cell change configuration information sent by the terminal, the network device may send to the terminal the cell change configuration information.

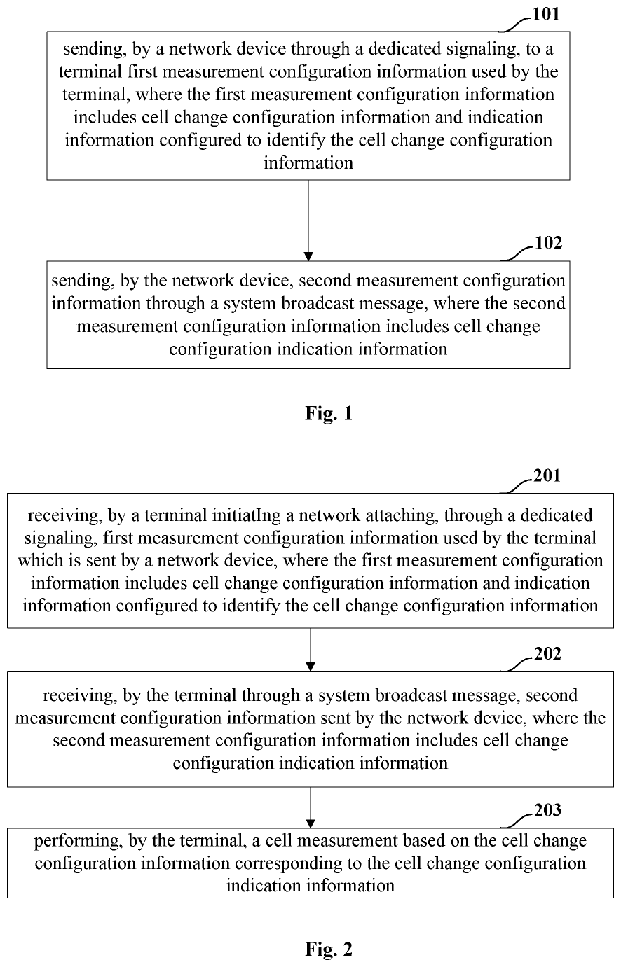

As shown in FIG. 2 which is a flowchart of a method for receiving cell measurement configuration information in some embodiments of the present disclosure, the method includes the following steps:

Step 201: receiving, by a terminal through a dedicated signaling, first measurement configuration information used by the terminal which is sent by a network device, where the first measurement configuration information includes cell change configuration information and indication information configured to identify the cell change configuration information.

Optionally, the cell change configuration information used by the terminal is determined according to a capability of the terminal.

Optionally, the first measurement configuration information received by the terminal further includes a preset threshold for triggering cell change, that is, when the terminal detects that the signal quality of the serving cell of the terminal is lower than the preset threshold, the terminal is triggered to perform the cell change.

Step 202: receiving, by the terminal through a system broadcast message, second measurement configuration information sent by the network device, where the second measurement configuration information includes cell change configuration indication information.

Specifically, when the terminal is triggered to perform the cell change, the second measurement configuration information sent by the network device is received through the system broadcast message.

Step 203: performing, by the terminal, a cell measurement based on the cell change configuration information corresponding to the cell change configuration indication information.

Optionally, after the terminal enters from the first region to the second region where the network device is located, the terminal may send to the network device the acquisition request of the first measurement configuration information. After receiving the acquisition request of the first measurement configuration information sent by the terminal, the network device sends the first measurement configuration information to the terminal through the dedicated signaling, where the first measurement configuration information is determined by the terminal according to the measurement capability of the terminal and to be used by terminal in the second region where the network device is located. The first region and the second region are regions corresponding to different MMES, or the first region and the second region are regions corresponding to different cell groups, where one cell group includes several cells.

Optionally, the above cell change configuration indication information may be a cell change configuration index number, and the cell change configuration information and indication information configured to identify the cell change configuration information may include a correspondence between the cell change configuration information and cell change configuration index numbers. In the correspondence between the cell change configuration information and the cell change configuration index numbers of the same terminal, different cell change configuration index numbers correspond to different cell change configuration information. The cell change configuration indication information may also be used to instruct the terminal to acquire cell change configuration information through a system broadcast message.

Correspondingly, the terminal receives the cell change configuration index number sent by the network device, and performs the cell measurement according to the cell change configuration information corresponding to the index number. If the cell change configuration indication information sent by the network device and receive by the terminal is to instruct the terminal to acquire the indication information of the cell change configuration information, the terminal may acquire the cell change configuration information by receiving the system broadcast message sent by the network device.

The cell change configuration information in the first measurement configuration information sent by the network device to the terminal is determined according to the measurement capability of the terminal. Therefore, for different terminals, the cell change configuration information corresponding to the same index number may be the same or different.

Optionally, the cell change configuration information includes one or more of:

a frequency point and a bandwidth allowable to be measured; and

a serving cell identity.

In some embodiments of the present disclosure, after the terminal receives the second measurement configuration information that is sent by the network device and includes the cell change configuration indication information but does not find the cell change configuration information corresponding to the cell change configuration indication information in the correspondence between the cell change configuration information and the indication information configured to identify the cell change configuration information, the terminal may send to the network device an acquisition request of the cell change configuration information. After receiving the acquisition request of the cell change configuration information sent by the terminal, the network device may send to the terminal the cell change configuration information.

According to the embodiments of the present disclosure, a network device sends, through a dedicated signaling, to a terminal first measurement configuration information used by the terminal, where the first measurement configuration information includes cell change configuration information and indication information configured to identify the cell change configuration information, and sends second measurement configuration information through a system broadcast message, where the second measurement configuration information includes cell change configuration indication information, so as to enable the terminal that receives the second measurement configuration information to perform the cell measurement based on the cell change configuration information corresponding to the cell change configuration indication information in the second measurement configuration information. Since the network device sends the measurement configuration information indication information, the signaling overhead of the system broadcast message may be saved.

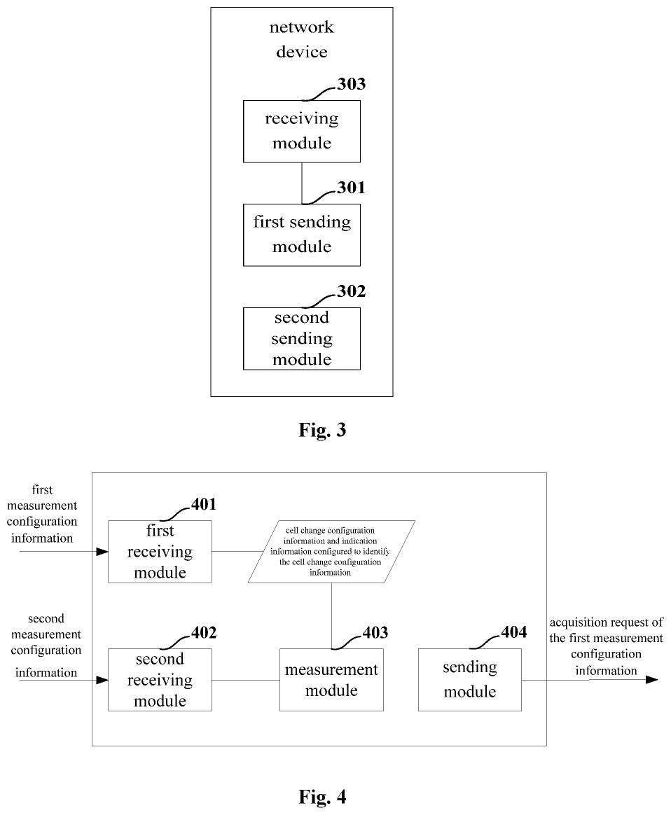

Based on the same technical concept, a network device for implementing the foregoing method is further provided in some embodiments of the present disclosure. As shown in FIG. 3 which is a schematic view of a network device in some embodiments of the present disclosure, the network device includes:

a first sending module 301, configured to send, through a dedicated signaling, to a terminal first measurement configuration information used by the terminal, where the first measurement configuration information includes cell change configuration information and indication information configured to identify the cell change configuration information;

a second sending module 302, configured to send, second measurement configuration information through a system broadcast message, where the second measurement configuration information includes cell change configuration indication information.

Optionally, the cell change configuration information used by the terminal is determined according to a capability of the terminal.

Optionally, the network device further includes:

a receiving module 303, configured to receive an acquisition request of the first measurement configuration information sent by the terminal, where the acquisition request is sent by a terminal from a first region after the terminal from the first region accessing a second region where the network device is located;

the first sending module 301 is further configured to send, through the dedicated signaling, the first measurement configuration information to the terminal that sends the acquisition request.

Optionally, the first region is corresponding to a first MME, the second region is corresponding to a second MME, or

the first region is corresponding to a first cell group, the second region is corresponding to a second cell group, the first cell group includes N cells, N is an integer greater than or equal to 1, the second cell group includes M cells, M is an integer greater than or equal to 1.

Optionally, the cell change configuration information and the indication information configured to identify the cell change configuration information include: a correspondence between the cell change configuration information and cell change configuration index numbers;

the different cell change configuration index numbers used by the terminal correspond to different cell change configuration information;

the cell change configuration information corresponding to a same cell change configuration index number used by different terminals is the same or different.

Optionally, the cell change configuration information includes one or more of:

a frequency point and a bandwidth allowable to be measured; and

a serving cell identity.

Based on the same technical concept, a terminal for implementing the foregoing method is further provided in some embodiments of the present disclosure. As shown in FIG. 4 which is a schematic view of a terminal in some embodiments of the present disclosure, the terminal includes:

a first receiving module 401, configured to receive, through a dedicated signaling, first measurement configuration information used by the terminal which is sent by a network device, where the first measurement configuration information includes cell change configuration information and indication information configured to identify the cell change configuration information;

a second receiving module 402, configured to receive, through a system broadcast message, second measurement configuration information sent by the network device, where the second measurement configuration information includes cell change configuration indication information; and

a measurement module 403, configured to perform a cell measurement based on the cell change configuration information corresponding to the cell change configuration indication information.

Optionally, the cell change configuration information used by the terminal is determined according to a capability of the terminal.

Optionally, the terminal further includes:

a sending module 404, configured to send an acquisition request of the first measurement configuration information to the network device, after the terminal enters from a first region to a second region where the network device is located;

the first receiving module 401 is further configured to receive the first measurement configuration information sent by the network device through the dedicated signaling, in the case that the sending module sends the acquisition request of the first measurement configuration information.

Optionally, the first region is corresponding to a first MME, the second region is corresponding to a second MME, or the first region is corresponding to a first cell group, the second region is corresponding to a second cell group, the first cell group includes N cells, N is an integer greater than or equal to 1, the second cell group includes M cells, M is an integer greater than or equal to 1.

Optionally, the cell change configuration information and the indication information configured to identify the cell change configuration information include: a correspondence between the cell change configuration information and cell change configuration index numbers;

the different cell change configuration index numbers used by the terminal correspond to different cell change configuration information;

the cell change configuration information corresponding to a same cell change configuration index number used by different terminals is the same or different.

Optionally, the cell change configuration information includes one or more of:

a frequency point and a bandwidth allowable to be measured; and

a serving cell identity.

According to the embodiments of the present disclosure, a network device sends, through a dedicated signaling, to a terminal first measurement configuration information used by the terminal, where the first measurement configuration information includes cell change configuration information and indication information configured to identify the cell change configuration information, and sends second measurement configuration information through a system broadcast message, where the second measurement configuration information includes cell change configuration indication information, so as to enable the terminal that receives the second measurement configuration information to perform the cell measurement based on the cell change configuration information corresponding to the cell change configuration indication information in the second measurement configuration information. Since the network device sends the measurement configuration information indication information, the signaling overhead of the system broadcast message may be saved.

The present disclosure has been described with reference to the flow charts and/or block diagrams of the method, device (system) and computer program product according to the embodiments of the present disclosure. It should be understood that computer program instructions may be used to implement each of the work flows and/or blocks in the flow charts and/or the block diagrams, and the combination of the work flows and/or blocks in the flow charts and/or the block diagrams. These computer program instructions may be provided to a processor of a common computer, a dedicate computer, an embedded processor or any other programmable data processing devices to create a machine, so that instructions executable by the processor of the computer or the other programmable data processing devices may create a device to achieve the functions assigned in one or more work flows in the flow chart and/or one or more blocks in the block diagram.

These computer program instructions may also be stored in a computer readable storage that may guide the computer or the other programmable data process devices to function in a certain way, so that the instructions stored in the computer readable storage may create a product including an instruction unit which achieves the functions assigned in one or more flows in the flow chart and/or one or more blocks in the block diagram.

These computer program instructions may also be loaded in the computer or the other programmable data process devices, so that a series of operation steps are executed on the computer or the other programmable devices to create processes achieved by the computer. Therefore, the instructions executed in the computer or the other programmable devices provide the steps for achieving the function assigned in one or more flows in the flow chart and/or one or more blocks in the block diagram.

While the embodiments of the present disclosure are described, it will be apparent that those skilled in the art can make further changes and modifications to the embodiments. Therefore, the appended claims are intended to be interpreted as including the embodiments and the changes and modifications within the scope of the present disclosure.

Obviously, a person skilled in the art may make further modifications and improvements without departing from the principle of the present disclosure, and these modifications and improvements shall also fall within the scope of the present disclosure.

1. A method of sending cell measurement configuration information, comprising:
sending, by a network device through a dedicated signaling, to a terminal first measurement configuration information used by the terminal, wherein the first measurement configuration information comprises cell change configuration information and indication information configured to identify the cell change configuration information;
sending, by the network device, second measurement configuration information through a system broadcast message, wherein the second measurement configuration information comprises cell change configuration indication information.

2. The method according to claim 1, wherein the cell change configuration information used by the terminal is determined according to a capability of the terminal.

3. The method according to claim 1, further comprising:
receiving, by the network device, an acquisition request of the first measurement configuration information sent by the terminal, wherein the acquisition request is sent by a terminal from a first region after the terminal from the first region accessing a second region where the network device is located;
sending, by the network device through the dedicated signaling, the first measurement configuration information to the terminal that sends the acquisition request.

4. The method according to claim 3, wherein the first region is corresponding to a first MME, the second region is corresponding to a second MME, or
the first region is corresponding to a first cell group, the second region is corresponding to a second cell group, the first cell group comprises N cells, N is an integer greater than or equal to 1, the second cell group comprises M cells, M is an integer greater than or equal to 1.

5. The method according to claim 1, wherein the cell change configuration information and the indication information configured to identify the cell change configuration information comprise: a correspondence between the cell change configuration information and cell change configuration index numbers;
the different cell change configuration index numbers used by the terminal correspond to different cell change configuration information;
the cell change configuration information corresponding to a same cell change configuration index number used by different terminals is the same or different;
wherein the cell change configuration information comprises one or more of: a frequency point and a bandwidth allowable to be measured; and a serving cell identity.

6. (canceled)

7. A method of receiving cell measurement configuration information, comprising:
receiving, by a terminal through a dedicated signaling, first measurement configuration information used by the terminal which is sent by a network device, wherein the first measurement configuration information comprises cell change configuration information and indication information configured to identify the cell change configuration information;
receiving, by the terminal through a system broadcast message, second measurement configuration information sent by the network device, wherein the second measurement configuration information comprises cell change configuration indication information; and
performing, by the terminal, a cell measurement based on the cell change configuration information corresponding to the cell change configuration indication information.

8. The method according to claim 7, wherein the cell change configuration information used by the terminal is determined according to a capability of the terminal.

9. The method according to claim 7, further comprising:
sending, by the terminal, an acquisition request of the first measurement configuration information to the network device, after the terminal enters from a first region to a second region where the network device is located;
receiving, by the terminal, the first measurement configuration information sent by the network device through the dedicated signaling.

10. The method according to claim 9, wherein the first region is corresponding to a first MME, the second region is corresponding to a second MME, or
the first region is corresponding to a first cell group, the second region is corresponding to a second cell group, the first cell group comprises N cells, N is an integer greater than or equal to 1, the second cell group comprises M cells, M is an integer greater than or equal to 1.

11. The method according to claim 7, wherein the cell change configuration information and the indication information configured to identify the cell change configuration information comprise: a correspondence between the cell change configuration information and cell change configuration index numbers;
the different cell change configuration index numbers used by the terminal correspond to different cell change configuration information;
the cell change configuration information corresponding to a same cell change configuration index number used by different terminals is the same or different;
wherein the cell change configuration information comprises one or more of: a frequency point and a bandwidth allowable to be measured; and a serving cell identity.

12. (canceled)

13. A network device, comprising: a transceiver, a processor and a memory configured to store a program or data used by the processor, wherein the processor is configured to read the program or data stored in the memory to:
send, through a dedicated signaling, to a terminal first measurement configuration information used by the terminal, wherein the first measurement configuration information comprises cell change configuration information and indication information configured to identify the cell change configuration information;
send, second measurement configuration information through a system broadcast message, wherein the second measurement configuration information comprises cell change configuration indication information.

14. The network device according to claim 13, wherein the cell change configuration information used by the terminal is determined according to a capability of the terminal.

15. The network device according to claim 13, wherein the processor is further configured to read the program or data stored in the memory to:
receive an acquisition request of the first measurement configuration information sent by the terminal, wherein the acquisition request is sent by a terminal from a first region after the terminal from the first region accessing a second region where the network device is located;
send, through the dedicated signaling, the first measurement configuration information to the terminal that sends the acquisition request.

16. The network device according to claim 15, wherein the first region is corresponding to a first MME, the second region is corresponding to a second MME, or
the first region is corresponding to a first cell group, the second region is corresponding to a second cell group, the first cell group comprises N cells, N is an integer greater than or equal to 1, the second cell group comprises M cells, M is an integer greater than or equal to 1.

17. The network device according to claim 13, wherein the cell change configuration information and the indication information configured to identify the cell change configuration information comprise: a correspondence between the cell change configuration information and cell change configuration index numbers;
the different cell change configuration index numbers used by the terminal correspond to different cell change configuration information;
the cell change configuration information corresponding to a same cell change configuration index number used by different terminals is the same or different;
wherein the cell change configuration information comprises one or more of: a frequency point and a bandwidth allowable to be measured; and a serving cell identity.

18. (canceled)

19. A terminal, comprising: a transceiver, a processor and a memory configured to store a program or data used by the processor, wherein the processor is configured to read the program or data stored in the memory to perform the method of receiving cell measurement configuration information according to claim 7.

20. The terminal according to claim 19, wherein the cell change configuration information used by the terminal is determined according to a capability of the terminal.

21. The terminal according to claim 19, wherein the processor is further configured to read the program or data stored in the memory to:
send an acquisition request of the first measurement configuration information to the network device, after the terminal enters from a first region to a second region where the network device is located;
receive the first measurement configuration information sent by the network device through the dedicated signaling, in the case that the sending module sends the acquisition request of the first measurement configuration information.

22. The terminal according to claim 21, the first region is corresponding to a first MME, the second region is corresponding to a second MME, or
the first region is corresponding to a first cell group, the second region is corresponding to a second cell group, the first cell group comprises N cells, N is an integer greater than or equal to 1, the second cell group comprises M cells, M is an integer greater than or equal to 1.

23. The terminal according to claim 19, wherein the cell change configuration information and the indication information configured to identify the cell change configuration information comprise: a correspondence between the cell change configuration information and cell change configuration index numbers;
the different cell change configuration index numbers used by the terminal correspond to different cell change configuration information;
the cell change configuration information corresponding to a same cell change configuration index number used by different terminals is the same or different;
wherein the cell change configuration information comprises one or more of: a frequency point and a bandwidth allowable to be measured; and a serving cell identity.

24.-28. (canceled)
